(19) United States
(12) Patent Application Publication
(10) Pub. No.: US 2009/0276951 A1
(43) Pub. Date: Nov. 12, 2009

(54) BUBBLE GENERATION ASSEMBLY

(75) Inventor: Minh Sang TRAN, Cambridge (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: GULFSTREAM PLASTICS LTD., Cambridge (CA)

(21) Appl. No.: 12/421,738

(22) Filed: Apr. 10, 2009

Related U.S. Application Data
(60) Provisional application No. 61/044,596, filed on Apr. 14, 2008.

(51) Int. Cl. A61H 33/00

(52) U.S. Cl. 4/541.5

(57) ABSTRACT

A bubble generation assembly for a basin, wherein the bubble generation assembly comprises: a base portion comprising a bottom surface, a raised edge, and a top surface comprising raised portions with a plurality of holes therein, wherein the base portion is configured to conform to a base of the basin and the bottom surface is configured to substantially conform to the basin; an extended portion, extending upwardly from the base portion and conforming to a wall of the basin, the extended portion comprising an extended raised portion; wherein the extended raised portion and the raised portions of the base portion are in communication to allow a flow of air from the extended portion to the holes in the raised portions of the base portion.

### CROSS REFERENCE TO RELATED APPLICATIONS

This application claims the benefit of priority of U.S. Provisional Patent Application No. 61/044,596, filed Apr. 14, 2008, which is incorporated herein by reference in its entirety.

### FIELD

This application relates to a bubble generation assembly, and in particular to a disposable bubble generation assembly for use with disposable liners within baths, such as foot baths. Although reference is made herein to “foot baths”, it should be understood that the bubble generation assembly can be applied to any of various baths, and in particular, to those where hygienic problems similar to those described below could arise.

### BACKGROUND

In the spa industry, standards with regard to sanitary conditions being dictated by best practices as well as by regulation and legislation are becoming increasingly stringent. In California now, for example, it is the applicant's understanding that a tub used for manicures or pedicures must be drained after each use, filled with fresh water and a cleaning solution, then circulated for 15 minutes, and dried, all before the next spa customer can be accepted. A typical session with a spa client might be a half-hour. When the cleaning process must be employed, it will be appreciated that the spa owner or operator thus can only process one client per hour per spa, instead of two or perhaps three. The impact on profitability is obvious.

The need to maintain sanitary conditions is further complicated by air or water jets that are often desired in the basins/tubs. For example, water or air jets commonly have been permanently mounted and may have permanently installed pipes, to circulate water or air in the tub for therapy and relaxation. For example, there may be a pump installed adjacent to, remote from, or on the tub, with inlet and outlet pipes leading to the tub from the pump location. This can lead to problems of infection or other health issues due to the difficulty of adequately cleaning and sanitizing the pipes between uses. Buildup of algae, fungus, bacteria and mold can be problematic.

While there have been attempts to incorporate air or water flow through a disposable liner that can be installed in the tub/basin to maintain sanitary conditions, these known attempts are complex, expensive to make and difficult to use. As such, there is a need for an improved air flow system for use in spa basins/tubs.

### SUMMARY

In view of the above, it is an object of embodiments of the bubble generation assembly herein to address at least some of the problems relating to air flow in spa basins while maintaining appropriate sanitary conditions.

According to one aspect, there is provided a bubble generation assembly for a basin, the bubble generation assembly comprising: a base portion comprising a bottom surface, a raised edge, and a top surface comprising raised portions with a plurality of holes therein, wherein the base portion is configured to conform to a base of the basin and the bottom surface is configured to substantially conform to the basin; an extended portion, extending upwardly from the base portion and conforming to a wall of the basin, the extended portion comprising an extended raised portion; wherein the extended raised portion and the raised portions of the base portion are in communication to allow a flow of air from the extended portion to the holes in the raised portions of the base portion.

In a particular case, the bubble generation assembly may include a base portion wherein the base portion further includes a stopper portion extending downwardly and configured to act as a stopper in a drain of the basin.

In another case, the raised portions may comprise concentric circles arranged on the base portion.

In yet another case, the base portion and extended portion may comprise a top and a bottom that are joined during manufacturing.

In still yet another case, the bubble generation assembly may be formed from a flexible plastic. Further, the flexible plastic may be selected such that the extended portion is able to remain substantially upright conforming to the shape of the basin even when not otherwise supported.

In yet a further case, the bubble generation assembly may be configured to assemble with a liner installed in the basin.

It will be understood that the bubble generation assembly may be configured to be disposable.

Further details of the bubble generation assembly will be described or will become apparent in the course of the following detailed description and references to the drawings of specific embodiments.

### BRIEF DESCRIPTION OF THE DRAWINGS

Embodiments will now be described, by way of example only, with reference to the attached drawings, in which:

FIG. 1 is a perspective view showing a spa chair and basin;

FIG. 2 is an exploded perspective view, showing a basin, a liner, and a bubble generation assembly;

FIG. 3 is a perspective view of the elements of FIG. 2, showing the liner and bubble generation assembly installed in the basin;

FIG. 4 is an exploded perspective view showing top and bottom portions of the bubble generation assembly;

FIG. 5A is a top view of the bubble generation assembly;

FIG. 5B is a cross-sectional view of the bubble generation assembly along the section 5B-5B of FIG. 5A;

FIG. 5C is a cross-sectional view of the bubble generation assembly along the section 5C-5C of FIG. 5A;

FIG. 6A is a perspective cross-sectional view showing the bubble generation assembly installed in the liner and basin;

FIG. 6B is a side cross-sectional view, showing the bubble generation assembly mounted in the liner and basin;

FIG. 7 is a detailed cross-sectional view of a portion of the basin shown in FIG. 6B;

FIG. 8 is a detailed cross-sectional view of a portion of the basin shown in FIG. 6B;

FIG. 9 is a detailed cross-sectional view of a portion of the basin shown in FIG. 6B;

FIG. 10 is a cross-section showing the basin, liner, and bubble generation assembly during use; and

FIG. 11 is a perspective view showing removal of the bubble generation assembly from the basin.

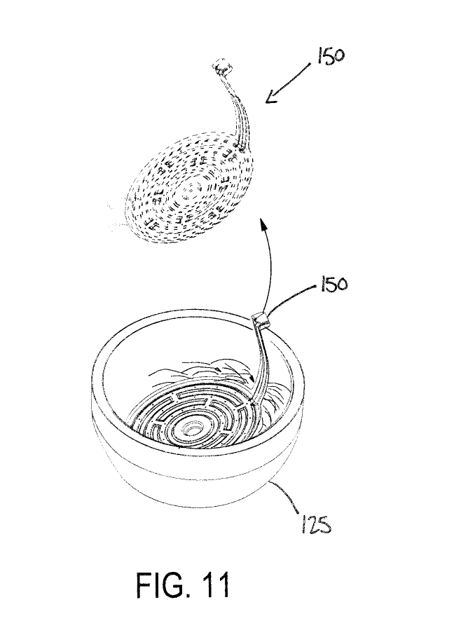

### DETAILED DESCRIPTION

In the following description, various embodiments will be described. For purposes of explanation, specific configurations and details are set forth in order to provide a thorough understanding of the embodiments. However, it will also be apparent to one skilled in the art that the bubble generation assembly may be practiced without the specific details. Furthermore, well-known features may be omitted or simplified in order not to obscure the embodiment being described.

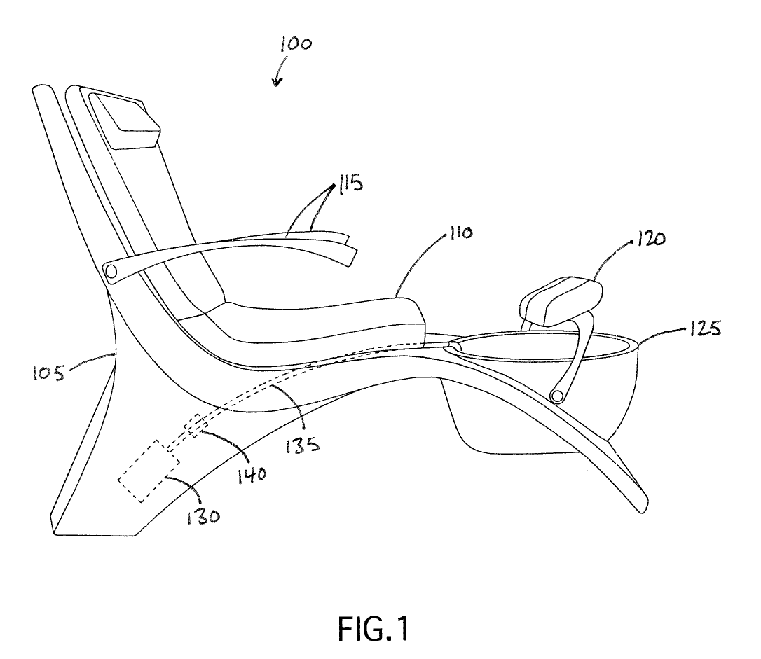

FIG. 1 shows an example spa chair 100 for use with, in this example, pedicures. The spa chair 100 includes a body 105, a seating portion 110, arm rests 115, and a foot rest 120. A basin 125 for water is placed adjacent to the foot rest 120 for insertion of a client's feet to allow for soaking feet as a part of a pedicure procedure.

Also shown in FIG. 1 is an air compressor 130 and an air tube 135 connected to the compressor 130 via a valve 140. The air tube 135 runs from the compressor 130 to an area adjacent to the basin 125. It will be understood that the compressor 130, air tube 135 and valve 140 may be positioned internally or externally to the spa chair 100 and may be controlled and powered in various ways as are known in the art.

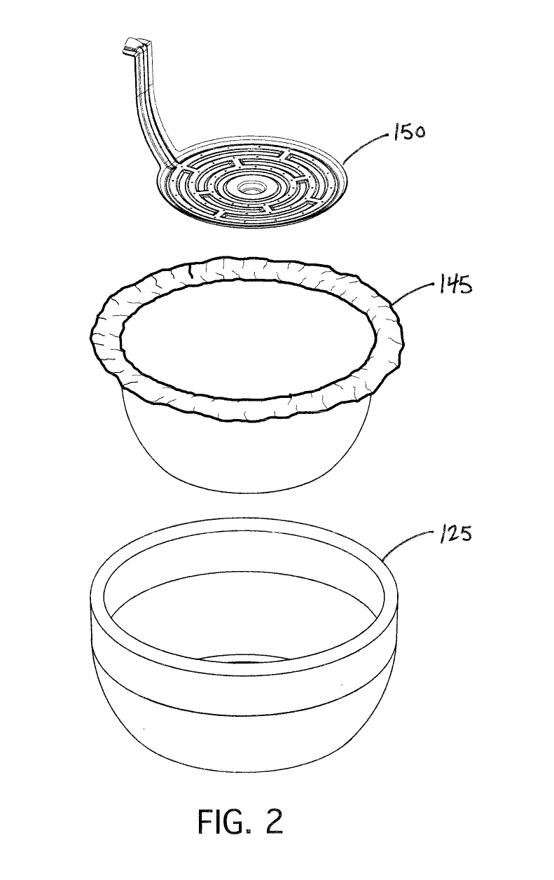

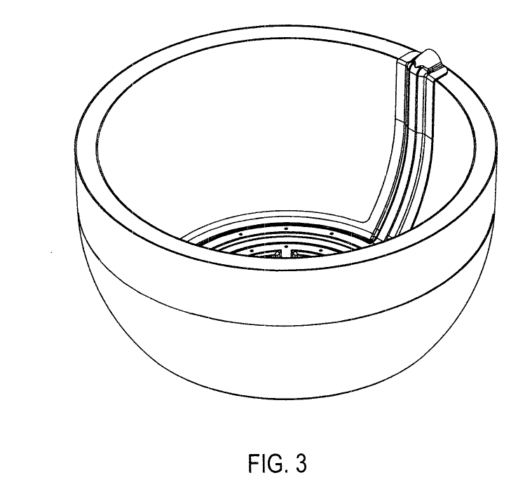

FIG. 2 shows the basin 125, as well as a liner 145 and a bubble generation assembly 150 according to one embodiment herein. As shown, the liner 145 is inserted into the basin 125 and the bubble generation assembly 150 is then inserted into the liner 145. The combination of the basin 125, liner 145 and bubble generation assembly 150 is shown in FIG. 3. While the example herein relates to a basin for a pedicure, it will be understood that embodiments of the bubble generation assembly described herein may also be used in various other applications and in various types of basins. It will further be understood that the liner 145 and bubble generation assembly 150 are preferably disposable or recyclable so that they can be removed and replaced after a treatment to provide a sanitary cover in the basin 125.

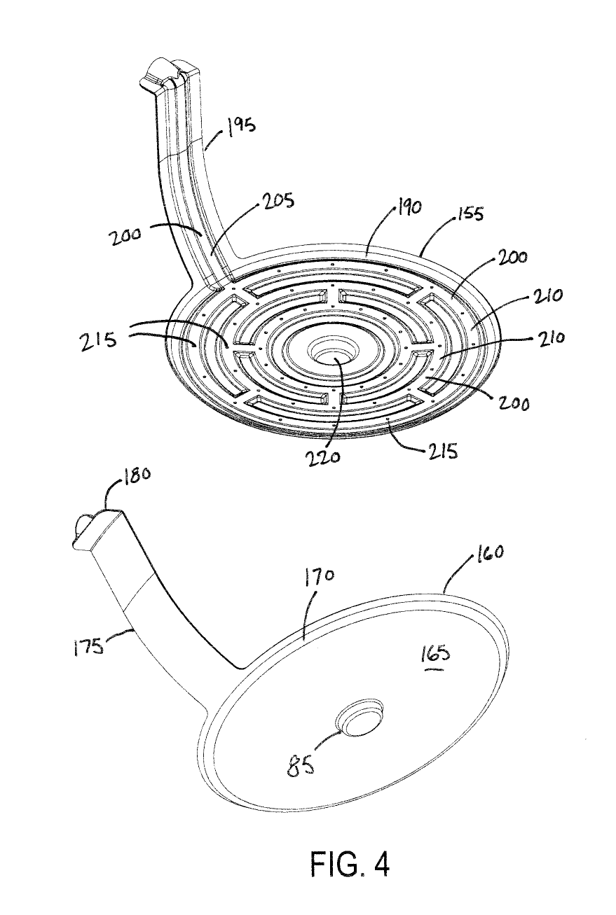

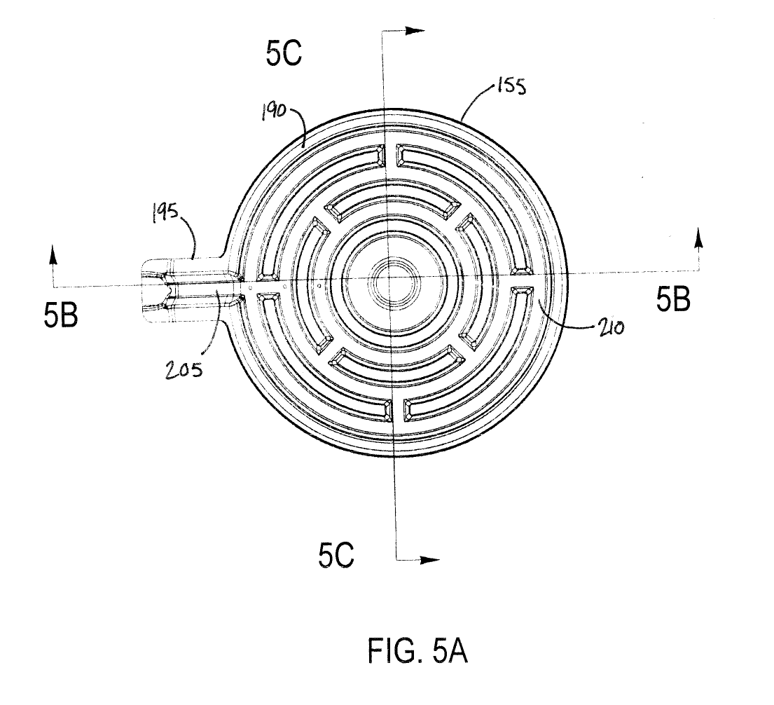

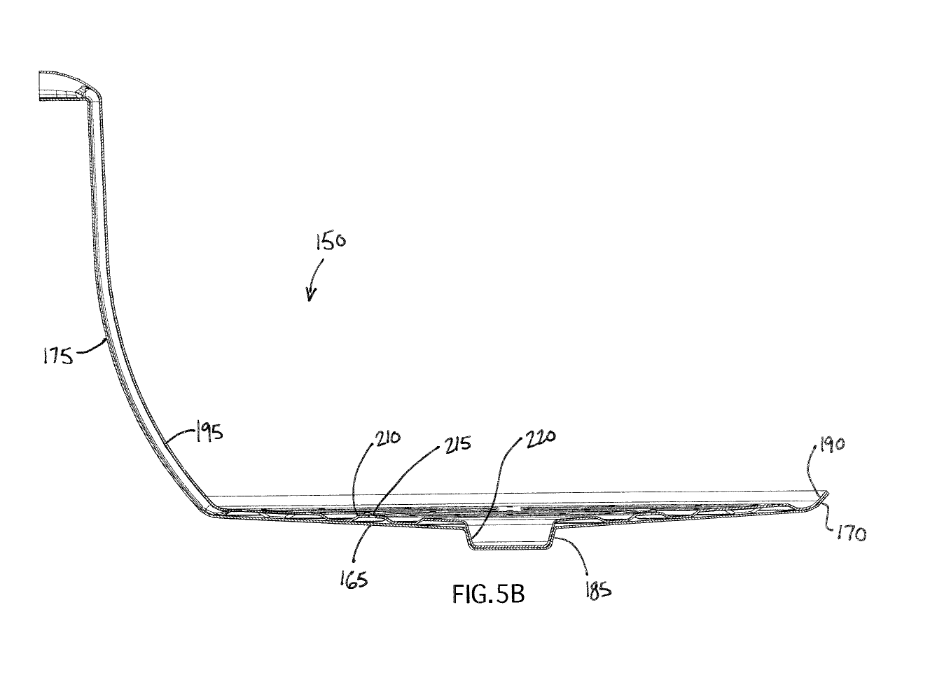

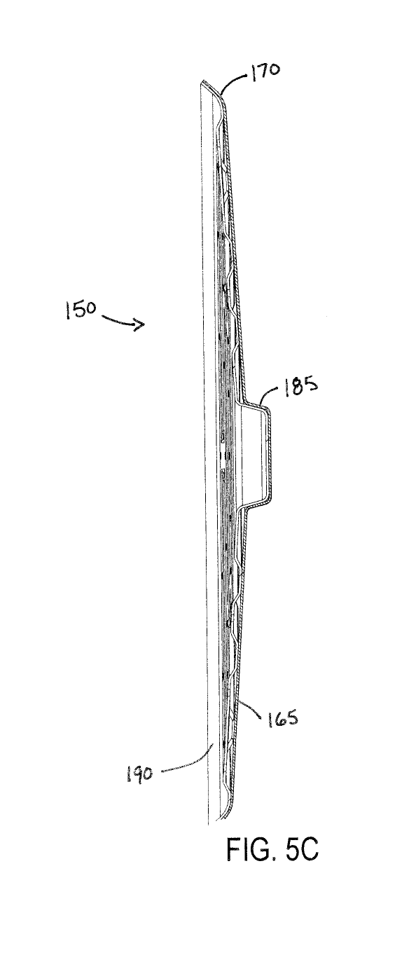

FIG. 4 shows an exploded view of the bubble generation assembly 150. As shown, the bubble generation assembly 150 includes a top portion 155 and a bottom portion 160. In this embodiment, the bubble generation assembly 150 is formed in two parts in order to facilitate fabrication, however, it will be understood that this is not a requirement. The top portion 155 and the bottom portion 160 are typically made out of a suitable plastic material and may be formed by various known techniques. FIGS. 5A, 5B and 5C show further detail of the bubble generation assembly 150.

As shown in FIG. 4 and FIGS. 5A, 5B and 5C, the bottom portion 160 of the bubble generation assembly 150 has a flat dish-like shape with a flat bottom 165 and a raised edge 170. The bottom portion 160 includes an extended portion 175 which is connected to and extends upward from the raised edge 170. The extended portion 175 includes a lip 180 opposite the connection to the raised edge 170 that extends generally horizontally from the extended portion 175. It will be understood that the size and shape of the bubble generation assembly 150 is configured to conform to the size and shape of the basin 125 used in a particular type of spa or other treatment. Various sizes and shapes may be possible depending on the basin to be used. Similarly, the extended portion 175 is configured to conform to the shape of the basin 125 and the lip 180 is configured to extend over a lip of the basin 125. The lower portion 160 also includes a stopper portion 185 that is configured to act as a stopper in a drain of the basin 125. It will be understood that the positioning of the stopper portion 185 will be designed to match with the drain in the basin 125.

The upper portion 155 of the bubble generation assembly 150 is configured to generally conform with and fit together with the bottom portion 160. The upper portion 155 include a base 188, an upper raised edge 190 and an upper extended portion 195. In addition, the upper portion 155 includes raised areas 200 that allow for the flow of air between the top portion 155 and the bottom portion 160. The raised areas 200 include a raised portion 205 running along the extended portion 195 that is connected to several concentric circles 210 on the base 188 of the top portion 155 for air flow. Further, the concentric circles 210 include several holes 215 through which air can pass out of the concentric circles 210 to provide the bubbling effect. It will be understood that the actual configuration of the raised areas 200 may be varied as long as there is a path for air to flow from the extended portion through to the holes 215, so that the air can be vented through the holes 215 into the basin 125. The upper portion 155 also includes an upper stopper portion 220 that is configured to join with the stopper portion 185 of the lower portion 160.

The upper portion 155 and lower portion 160 of the bubble generation assembly 150 may be assembled by various methods as known in the art such as adhesive, heat bonding, and similar methods of bonding plastic elements together. When assembled together the top portion 155 and bottom portion 160 form a base portion having a flat bottom surface and a top surface having raised portions with holes therein as well as an extended portion extending upwardly from the base portion and having an extended raised portion in communication with the raised portion on the base portion.

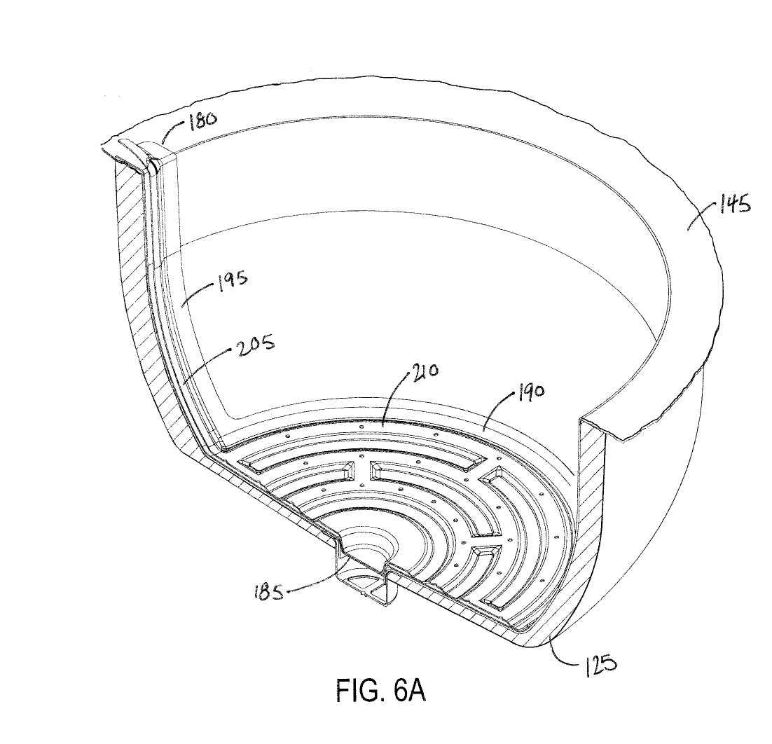

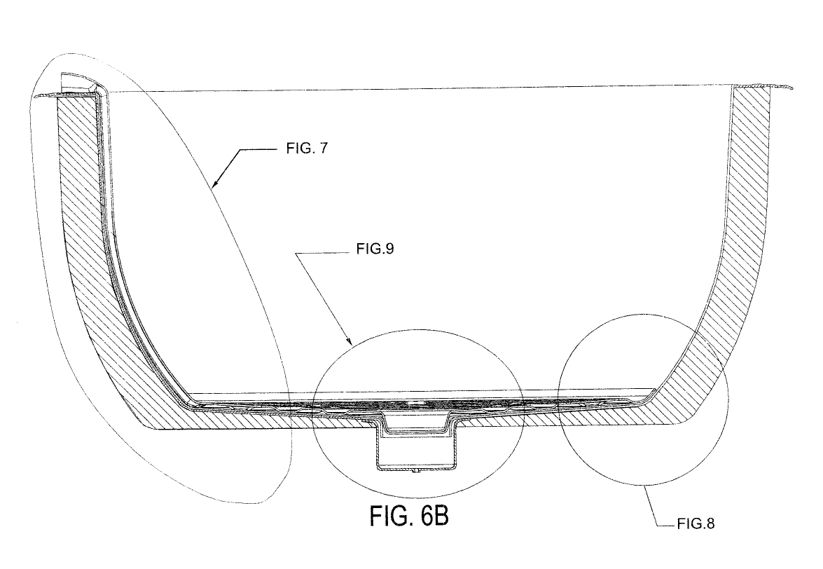

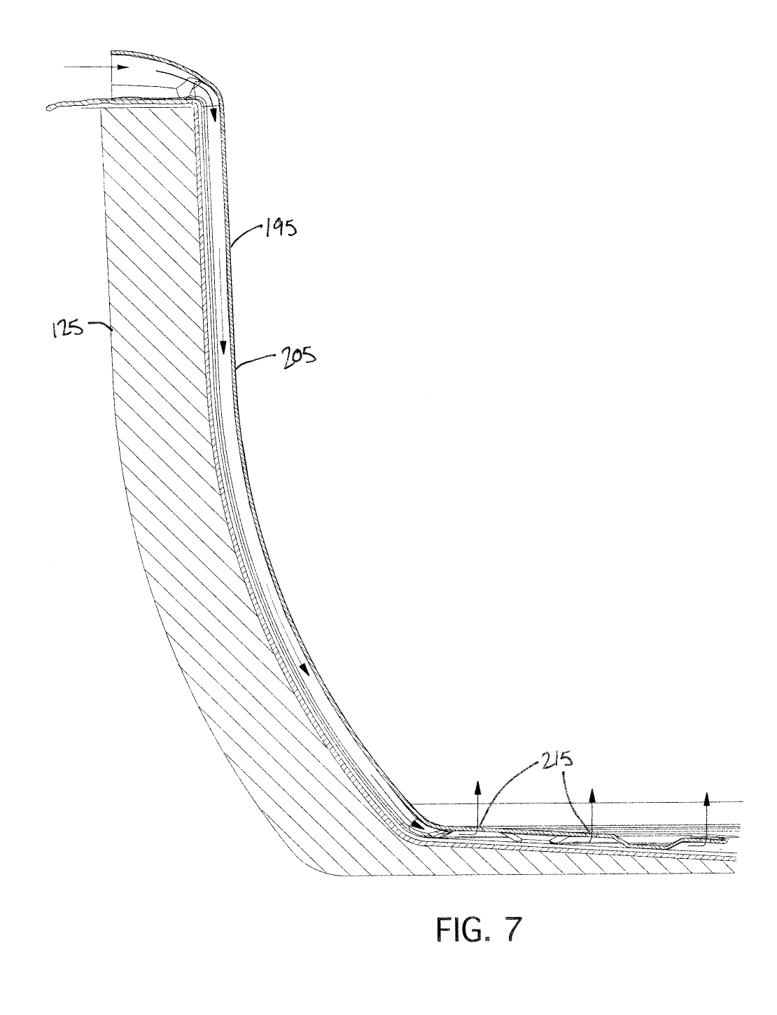

FIG. 6A is a cross section perspective view of the bubble generation assembly 150 as positioned in the basin 125 and showing the stopper portion 185 inserted into the drain of the basin 125. FIG. 6B is a side cross sectional view illustrating the arrangement of FIG. 6A and showing detail areas shown in FIGS. 7, 8 and 9.

FIG. 7 shows a detailed view of the extended portion 195 of the bubble generation assembly 150 and illustrates a flow of air into the bubble generation assembly 150. The air tube of FIG. 1 (not shown in FIG. 7) is connected to the raised portion 205 of the extended portion 195. The flow of air (shown by the arrows) travels down the extended portion 175/195 into the concentric circles 210 and out of the holes 215 of the top portion 155 of the bubble generation assembly 150.

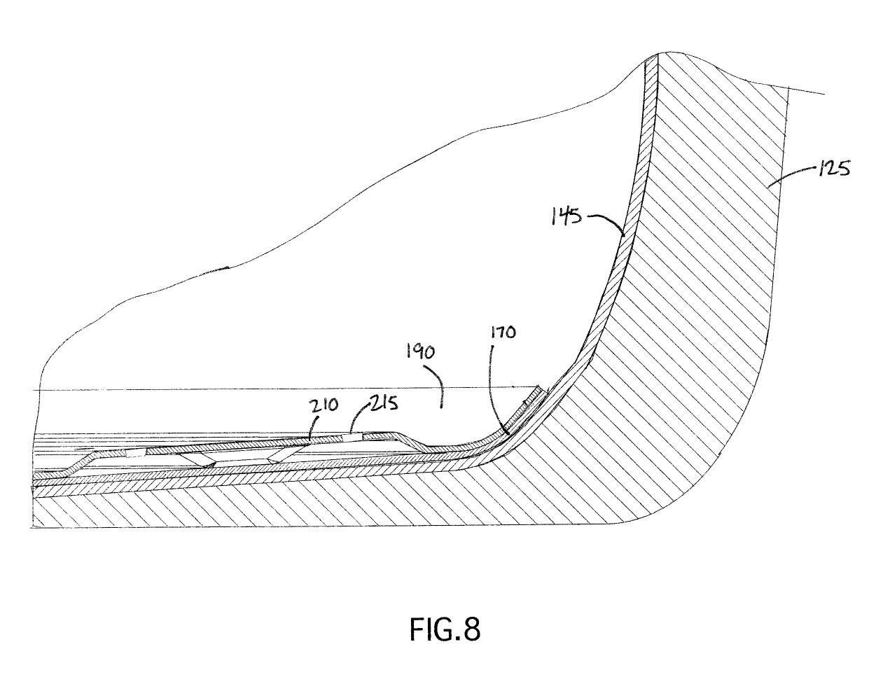

FIG. 8 shows a detail of the raised edge 170/190 of the bubble generation assembly 150. As shown, the raised edge 170/190 is configured to conform to the liner 145 and the basin 125 to provide a seal to prevent water from entering between the bubble generation assembly 150 and the liner 145, so that the bubble generation assembly 150 will remain in place as water fills the basin 125.

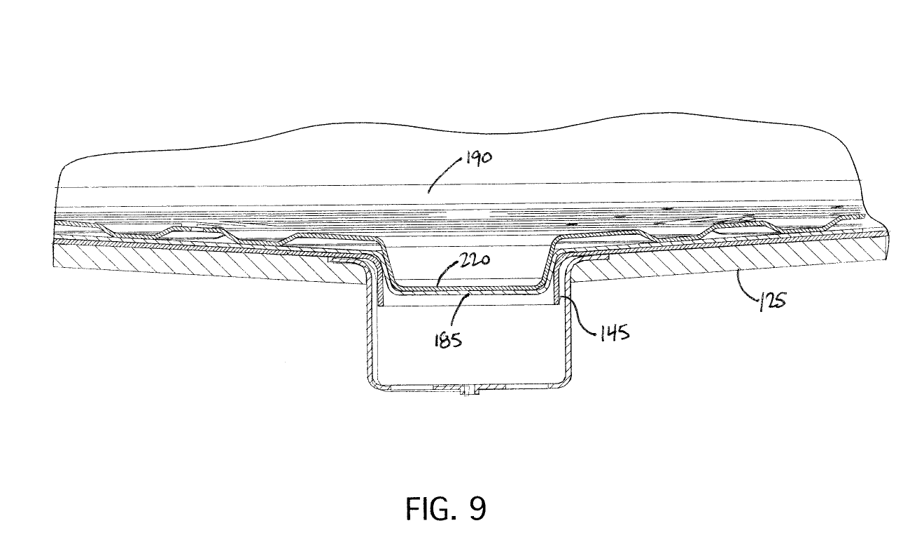

FIG. 9 shows detail of the drain of the basin 125. As illustrated, the drain extends downward from the basin 125. The liner 145 extends into the drain a sufficient distance to ensure that water travels out the drain and will not enter back into the basin 125. The stopper portion 185/220 of the bubble generation assembly 150 is configured to fit into the drain of the liner 145 and basin 125 to act as a stopper and prevent water from exiting the basin until removed.

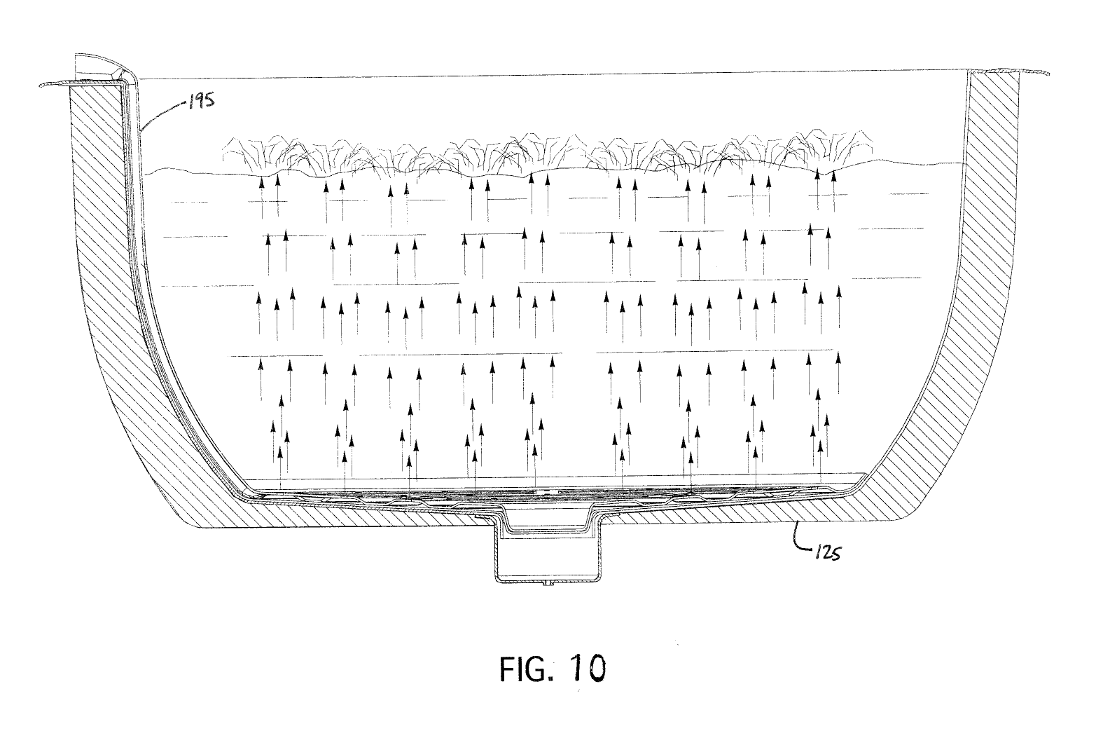

FIG. 10 is a cross sectional view showing the bubble generation assembly 150 in operation. In particular, the liner 145 is placed in the basin 125, the bubble generation assembly 150 is then placed on top of the liner 145 and the basin 125 is then filled with water. As the basin 125 fills with water, the bubble generation assembly 150 acts as a stopper to prevent the water from exiting the basin 125. The bubble generation assembly 150 can then be connected to an air tube, such as the example shown in FIG. 1. The air travels through the extended portion 175/195 and into the concentric circles 210 in the bubble generation assembly 150 and exits through the holes 215 and travels through the water to cause a spa effect.

Upon completion of the spa treatment, the bubble generation assembly 150 can be removed by pulling up on the extended portion 175/195 to allow water to flow through the drain of the basin 125. Both the bubble generation assembly 150 and the liner 145 can then be removed and replaced with a new liner and bubble generation assembly for a subsequent client of the spa.

The configuration of the bubble generation assembly 150 provides a number of benefits in that the bubble generation assembly 150 provides the access for air into the basin without any need for a separate air inlet within the basin itself, acts as a stopper, allows for quick and efficient release of the water in the basin, and maintains sanitary conditions for each client of the spa.

Variations of embodiments described herein may become apparent to those of ordinary skill in the art upon reading the foregoing description. It is expected that skilled persons will employ such variations as appropriate, and it is expected that the bubble generation assembly may be practiced otherwise than as specifically described herein. Accordingly, this application includes all modifications and equivalents of the subject matter described herein as permitted by applicable law. Moreover, any combination of the described elements in all possible variations thereof is encompassed by the application.

What is claimed is:

1. A bubble generation assembly for a basin, the bubble generation assembly comprising:
a base portion comprising a bottom surface, a raised edge, and a top surface comprising raised portions with a plurality of holes therein, wherein the base portion is configured to conform to a base of the basin and the bottom surface is configured to be substantially flat against the basin;
an extended portion, extending upwardly from the base portion and conforming to a wall of the basin, the extended portion comprising an extended raised portion;
wherein the extended raised portion and the raised portions of the base portion are in communication to allow a flow of air from the extended portion to the holes in the raised portions of the base portion.

2. A bubble generation assembly according to claim 1, wherein the base portion further comprises a stopper portion extending downwardly from the bottom surface and configured to act as a stopper in a drain of the basin.

3. A bubble generation assembly according to claim 1, wherein the raised portions comprise interconnected concentric circles arranged on the base portion.

4. A bubble generation assembly according to claim 1, wherein the base portion and extended portion each comprise a top and a bottom that are joined during manufacturing.

5. A bubble generation assembly according to claim 1, wherein the bubble generation assembly is formed from a flexible plastic.

6. A bubble generation assembly according to claim 5, wherein the flexible plastic is selected such that the extended portion is able to remain substantially rigid and conforming to the shape of the basin even when not otherwise supported.

7. A bubble generation assembly according to claim 1, wherein the bubble generation assembly is configured to assemble with a liner installed in the basin.

8. A bubble generation assembly according to claim 1, wherein the bubble generation assembly is configured to be disposable.
